(19) United States
(12) Patent Application Publication
(10) Pub. No.: US 2014/0250887 A1
(43) Pub. Date: Sep. 11, 2014

(54) POWER GENERATION SYSTEM MAKING USE OF LOW GRADE COAL

(71) Applicant: MITSUBISHI HEAVY INDUSTRIES, LTD., Tokyo (JP)

(72) Inventors: Takahito Yonekawa, Austin, TX (US); Shintaro Honjo, Austin, TX (US); Makoto Susaki, Austin, TX (US)

(73) Assignee: MITSUBISHI HEAVY INDUSTRIES, LTD., Tokyo (JP)

(21) Appl. No.: 13/785,206

(22) Filed: Mar. 5, 2013

(51) Int. Cl. F01K 13/00; B01D 53/62; C10L 9/08

(52) U.S. Cl. CPC F01K 13/00; C10L 9/083; B01D 53/62
USPC 60/670; 110/203; 110/218

(57) ABSTRACT

A power generation system using low-grade coal includes a low-grade coal refining facility that heats the low-grade coal to refine the low-grade coal into high-grade coal, a CO₂ recovery facility that recovers CO₂ from an exhaust gas generated by refining the low-grade coal in the low-grade coal refining facility, while using steam generated by refining the low-grade coal in the low-grade coal refining facility, and a power generation facility that performs the power generation using, as fuel, the high-grade coal obtained by refining the low-grade coal in the low-grade coal refining facility.

### TECHNICAL FIELD

The present invention relates to, for example, a power generation system using low-grade coal such as subbituminous coal or lignite.

### BACKGROUND ART

For example, low-grade coal such as subbituminous coal or lignite generally contains moisture, has a low carbonization degree, and has a low calorific value at the combustion. Further, if such low-grade coal is directly used as fuel for a power generation facility (a power generation plant) such as a coal-fired power plant, the power generation efficiency decreases and the amount of CO₂ emission per unit greatly increases. Accordingly, low-grade coal is used as a fuel of a power generation facility, for example, by supplying low-grade coal dried and refined in advance to a boiler or by providing a drying process before combustion in a power generation facility to perform refining for increasing a calorific value (e.g., see Patent Literature 1).

### CITATION LIST

### Patent Literature

[Patent Literature 1] Japanese Unexamined Patent Application, First Publication No. H11-082991

### SUMMARY OF INVENTION

### Problem to be Solved by the Invention

However, when low-grade coal is refined, it is necessary to obtain a heat source for drying the low-grade coal by burning the low-grade coal itself or by burning different fuel. Accordingly, the amount of CO₂ emission can be reduced by only several percent, e.g., about 2 to 3%, even when the low-grade coal is refined by applying labor and cost.

Further, a CO₂ recovery facility (a CO₂ recovery apparatus) for recovering and removing CO₂ from an exhaust gas exhausted from a boiler or the like in a power generation facility such as a coal-fired power plant has been proposed. This CO₂ recovery facility includes, for example, an absorption tower that brings an amine-based CO₂ absorption liquid into contact with an exhaust gas so that CO₂ in the exhaust gas is absorbed into the CO₂ absorption liquid, and a regeneration tower that dissociates and recovers CO₂ by heating, using steam, the CO₂ absorption liquid that has absorbed CO₂ in the absorption tower to regenerate the amine CO₂ absorption liquid.

Further, when such a CO₂ recovery facility is applied to a power generation facility such as a coal-fired power plant, steam generated in a boiler is used for regeneration of the CO₂ absorption liquid in the regeneration tower, which may cause degradation of turbine efficiency, and thus degradation of the amount of power generated of, for example, 20 to 30%. Furthermore, when low-grade coal is used as fuel, degradation of recovery efficiency of CO₂ and degradation of the amount of power generated may be caused.

Further, when a CO₂ recovery apparatus is applied to a coal-fired power plant, it is necessary to treat a large amount of exhaust gas, which may increase facility cost and cause a great increase in the cost of power generation.

### Means for Solving the Problem

According to a first aspect of the present invention, a power generation system using low-grade coal is a power generation system using low-grade coal as fuel for a boiler to perform power generation, and includes a low-grade coal refining facility that heats the low-grade coal to refine the low-grade coal into high-grade coal; a CO₂ recovery facility that recovers CO₂ from an exhaust gas generated by refining the low-grade coal in the low-grade coal refining facility, while using steam generated by refining the low-grade coal in the low-grade coal refining facility; and a power generation facility that performs the power generation using, as fuel, the high-grade coal obtained by refining the low-grade coal in the low-grade coal refining facility.

In the power generation system using low-grade coal, the power generation system may include a CO₂ transportation facility for transporting CO₂ recovered in the CO₂ recovery facility to an oil production plant.

In the power generation system using low-grade coal, the low-grade coal refining facility may be provided near a coal mine from which the low-grade coal is produced.

In the power generation system using low-grade coal, the CO₂ transportation facility may be a pipeline that connects the low-grade coal refining facility with the CO₂ recovery facility.

### Effects of Invention

In the power generation system using low-grade coal described above, it is possible to improve a calorific value and thus improve power generation efficiency of a coal-fired power plant by refining the low-grade coal in the low-grade coal refining facility provided separately from a power generation facility.

Further, it is possible to reduce the amount of exhaust gas at the time of use as boiler fuel by treating, in the CO₂ recovery facility provided separately from the power generation facility, the exhaust gas exhausted by refining the low-grade coal in the low-grade coal refining facility, and reduce the amount of emissions of environmental pollution such as CO₂, SO_{X}, NO_{X}, and Hg. Accordingly, it is possible to reduce capital costs and operational costs of a pollution control facility.

### BRIEF DESCRIPTION OF DRAWINGS

FIG. 1 is a diagram illustrating a power generation system according to an embodiment of the present invention.

### DESCRIPTION OF EMBODIMENTS

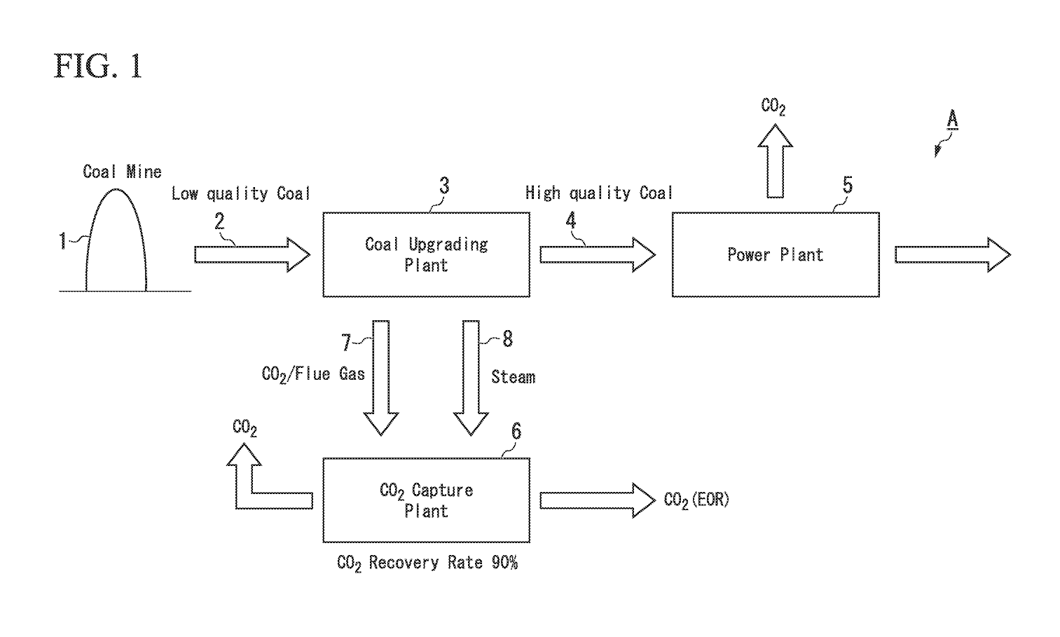

Hereinafter, a power generation system using low-grade coal according to an embodiment of the present invention will be described with reference to FIG. 1.

A power generation system A using low-grade coal of the present embodiment includes a low-grade coal refining facility 3 that refines low-grade coal (coal having low quality) 2 such as subbituminous coal or lignite produced from a mine 1, a power generation facility 5 that performs power generation using, as a fuel, high-grade coal (coal having high quality) 4 obtained by refining the low-grade coal 2 in the low-grade coal refining facility 3, and a CO₂ recovery facility 6 that recovers CO₂ generated in the low-grade coal refining facility 3, as shown in FIG. 1.

The low-grade coal refining facility 3 is a facility that heats the low-grade coal 2 to refine the low-grade coal 2 into the high-grade coal 4, and includes, for example, a drying/dry distillation apparatus that performs a drying treatment or a dry distillation treatment to heat the low-grade coal 2 and vaporize moisture.

The power generation facility 5 is a coal-fired power generation facility that includes a boiler that generates steam using coal as fuel, and a turbine driven by the steam generated in the boiler. Further, this power generation facility 5 is configured to perform power generation, for example, by driving a high pressure turbine by high pressure and high temperature steam generated in the boiler, overheating an exhaust gas of the high pressure turbine in a re-superheater of the boiler, driving a moderate pressure turbine by re-overheated moderate pressure steam, and driving a low pressure turbine using an exhaust gas of the moderate pressure turbine. Further, the power generation facility 5 includes an exhaust gas treating facility such as a condenser, a desulfurization apparatus, and a chimney.

The CO₂ recovery facility 6 includes an absorption tower for receiving exhaust gas 7 and steam 8 generated by heating the low-grade coal 2 in the low-grade coal refining facility 3 and bringing the exhaust gas 7 into contact with CO₂ absorption liquid to absorb and remove CO₂ from the exhaust gas 7, and a regeneration tower for receiving the CO₂ absorption liquid that has absorbed CO₂ in the absorption tower and separating and recovering CO₂ absorbed into the CO₂ absorption liquid.

In the absorption tower, an absorption liquid scrubber that sprays the CO₂ absorption liquid in a mist form is provided therein, and the CO₂ absorption liquid sprayed from this absorption liquid scrubber and the exhaust gas 7 introduced from the low-grade coal refining facility 3 to the inside of the absorption tower through a communication duct and flowing from a lower part of the absorption tower to an upper part thereof are brought into contact with each other. Accordingly, CO₂ in the exhaust gas 7 is dissolved in and absorbed into the CO₂ absorption liquid, and the treated exhaust gas from which CO₂ has been removed is released from the upper part to the outside. Further, the CO₂ absorption liquid having absorbed CO₂ is accumulated in the lower part of the absorption tower.

Further, it is desirable for the absorption tower to be configured to include a scrubber or a demister that sprays cooling water in a mist form, which is provided above the internal absorption liquid scrubber, and to capture and remove, using the cooling water, gaseous substances and particulate substances in the exhaust gas 7 that have not been collected into the CO₂ absorption liquid.

Further, for example, an amine-based absorption liquid may be adopted as the CO₂ absorption liquid. Specifically, an alkanolamine such as monoethanolamine, diethanolamine, triethanolamine, methyldiethanolamine, diisopropanolamine, or diglycolamine may be adopted as the CO₂ absorption liquid. Further, hindered amines may be adopted. Further, each water solution of the material or a water solution obtained by mixing two or more of the materials may be used as the CO₂ absorption liquid.

The regeneration tower separates and recovers CO₂ from the CO₂ absorption liquid that has absorbed CO₂ or the like in the absorption tower. An absorption liquid transportation pipe for introducing the CO₂ absorption liquid from the absorption tower is connected to an upper part of the regeneration tower. Further, the CO₂ absorption liquid accumulated in the lower part of the absorption tower is sprayed and supplied from the upper part to the inside of the regeneration tower by driving a liquid transportation pump of the absorption liquid transportation pipe. Further, in the regeneration tower, high temperature steam is supplied from the lower part and the sprayed CO₂ absorption liquid is heated. Accordingly, CO₂ is dissociated from the CO₂ absorption liquid and desorbed, and the desorbed CO₂ is derived from the upper part of the regeneration tower to the outside. Further, the derived CO₂ is cooled, compressed in a compressor, and is recovered as compressed CO₂.

In this case, in the present embodiment, the steam 8 generated when the low-grade coal 2 is heated and refined into the high-grade coal 4 in the low-grade coal refining facility 3 is provided to the regeneration tower, and the CO₂ absorption liquid is heated using the steam 8 generated in the low-grade coal refining facility 3. Accordingly, it is unnecessary to separately supply steam generated in a boiler or the like to the regeneration tower.

Further, the CO₂ absorption liquid from which CO₂ has been dissociated and removed in this way is accumulated in the lower part of the regeneration tower, a return pump provided in an absorption liquid supply pipe is driven, and the CO₂ absorption liquid is cooled by a cooler and sent to the absorption tower. In other words, in the present embodiment, the CO₂ absorption liquid having absorbed CO₂ or the like is sent from the absorption tower to the regeneration tower through the absorption liquid transportation pipe, and the CO₂ absorption liquid from which CO₂ has been recovered in the regeneration tower is returned from the regeneration tower to the absorption tower through the absorption liquid supply pipe again, to thereby circulate the CO₂ absorption liquid between the absorption tower and the regeneration tower so that the recovery of CO₂ is performed.

A simulation result for the power generation system using low-grade coal of the present embodiment will be described herein. First, for example, the low-grade coal refining facility 3 produces the high-grade coal 4 whose calorific value is 11,340 Btu/lb at a rate of 178 ton/h by treating the low-grade coal 2 whose calorific value is 8,000 Btu/lb at a rate of 308 ton/h. Accordingly, it was confirmed that when the high-grade coal 4 is used as fuel of the boiler of the coal fired power generation facility 5, a great calorific value can be obtained with a small amount of the high-grade coal 4 and the power generation efficiency increases by 2%. Further, when the low-grade coal 2 is refined into the high-grade coal 4 in the low-grade coal refining facility 3 in this way, CO₂ (10%-wet) of 2,778 tpd and the exhaust gas 7 of 586,835 Nm³/h are generated.

Further, when the high-grade coal 4 refined in the low-grade coal refining facility 3 is used as the fuel of the boiler of the coal fired power generation facility 5, the amount of CO₂ emissions are reduced to 9,246 tpd as compared with the amount of CO₂ emissions being 9,703 tpd when the lower coal 2 is used. Further, when the exhaust gas 7 exhausted from the low-grade coal refining facility 3 is treated in the CO₂ recovery facility 6 configured as described above, CO₂ in the exhaust gas 7 can be recovered at a recovery rate of 90%, recovering CO₂ of 2,500 tpd.

Further, according to the power generation system using low-grade coal of the present embodiment, it was confirmed that a total CO₂ exhaust ratio is changed from 940 ton/GWh to 881 ton/GWh, and a reduction of about 6%, as compared with a case in which the low-grade coal 2 is directly used.

Here, in an oil production plant, when the amount of collection of the oil using a primary collection method is decreased, artificial oil discharge energy is given to an oil layer to increase the amount of collection of the oil and increase a recovery rate of the oil. Further, an enhanced oil (crude oil) recovery technique (EOR: Enhanced Oil Recovery) includes a water flooding method of injecting water, a method of injecting natural gas, CO₂ or the like, a thermal recovery method, or a chemical method.

For example, the low-grade coal refining facility 3 is provided near the coal mine 1 from which the low-grade coal 2 is produced, the CO₂ recovery facility 6 is provided near the low-grade coal refining facility 3, and a CO₂ transportation facility that transports CO₂ recovered in the CO₂ recovery facility 6 to the oil production plant is provided, and this CO₂ transportation facility includes a pipeline that connects the CO₂ recovery facility 6 with the oil production plant, thereby constituting the power generation system A. With this configuration, it is possible to efficiently refine the low-grade coal 2 in the low-grade coal refining facility 3, the low-grade coal 2 produced from the coal mine 1 and produce the high-grade coal 4, and to efficiently treat the exhaust gas 7 in the CO₂ recovery facility 6, the exhaust gas 7 generated by refining the low-grade coal 2 in the low-grade coal refining facility 3.

Further, when the CO₂ transportation facility such as the pipeline transporting CO₂ recovered in the CO₂ recovery facility 6 to the oil production plant is provided, compressed CO₂ recovered in the CO₂ recovery facility 6 can be supplied to the oil production plant and used as CO₂ for EOR. Further, CO₂ recovered in the CO₂ recovery facility 6 may be accumulated deep underground to prevent CO₂ from being released to the atmosphere and causing global warming.

Accordingly, in the power generation system using low-grade coal of the present embodiment, it is possible to improve a calorific value and thus to improve the power generation efficiency of the coal-fired power plant 5 by refining the low-grade coal 2. Further, it is necessary to pulverize the low-grade coal 2 when the low-grade coal 2 is used as the fuel of the boiler, while it is possible to reduce mill power by refining the low-grade coal 2. Furthermore, when there is a sufficient turbine capacity, it is possible to increase the amount of power generated and achieve increase in power generation revenue by increasing the amount of using of the low-grade coal 2 (the amount of supply of the refined low-grade coal).

Further, it is possible to reduce the amount of exhaust gas at the time of use as the boiler fuel and reduce the amount of emissions of environmental pollution such as CO₂, SO_{X}, NO_{X}, and Hg, by refining the low-grade coal 2. Accordingly, it is possible to reduce capital costs and operational cost of a pollution control facility.

Further, it is possible to remove the environmental pollution such as CO₂, SO_{X}, NO_{X}, and Hg, and minimize emission reduction measure costs for the environmental pollution, by treating the exhaust gas 7 from the low-grade coal refining facility 3 with the CO₂ recovery facility 6.

Further, it is possible to reduce the amount of CO₂ emissions and use recovered CO₂ for, for example, EOR by treating CO₂ in the exhaust gas 7 from the low-grade coal refining facility 3 with the CO₂ recovery facility 6 which provided separately from the power generation facility 5.

Further, since the amount of exhaust gas can be reduced in the case in which the low-grade coal 2 is refined in the low-grade coal refining facility 3 compared with a case in which the low-grade coal 2 is directly used in the power generation facility 5, remodeling of an existing facility is minimized and facility costs can be greatly reduced.

Furthermore, by using the steam 8 generated with the low-grade coal refining facility 3 with the CO₂ recovery facility 6, it is possible to cause a power penalty to be zero and build an efficient power generation system using low-grade coal.

While the embodiment of the power generation system using low-grade coal according to the present invention has been described above, the present invention is not limited to the embodiment and may be appropriately modified without departing from the scope and spirit of the present invention.

### INDUSTRIAL APPLICABILITY

In the power generation system using low-grade coal described above, it is possible to improve a calorific value and thus improve power generation efficiency of a coal-fired power plant by refining the low-grade coal in the low-grade coal refining facility provided separately from the power generation facility.

Further, it is possible to reduce the amount of exhaust gas at the time of use as boiler fuel and reduce the amount of environmental pollution such as CO₂, SO_{X}, NO_{X}, or Hg, by treating, in the CO₂ recovery facility provided separately from the power generation facility, the exhaust gas exhausted by refining the low-grade coal in the low-grade coal refining facility. Accordingly, it is also possible to reduce the capital cost and operational costs of a pollution control facility.

### REFERENCE SIGNS LIST

1 mine (coal mine)
2 low-grade coal
3 low-grade coal refining facility
4 high-grade coal
5 power generation facility
6 CO₂ recovery facility
7 exhaust gas
8 steam
A power generation system using low-grade coal

1. A power generation system using low-grade coal as fuel for a boiler to perform power generation, the power generation system comprising:
a low-grade coal refining facility that heats the low-grade coal to refine the low-grade coal into high-grade coal;
a CO₂ recovery facility that recovers CO₂ from an exhaust gas generated by refining the low-grade coal in the low-grade coal refining facility, while using steam generated by refining the low-grade coal in the low-grade coal refining facility; and
a power generation facility that performs the power generation using, as fuel, the high-grade coal obtained by refining the low-grade coal in the low-grade coal refining facility.

2. The power generation system using low-grade coal according to claim 1, further comprising:
a CO₂ transportation facility for transporting CO₂ recovered in the CO₂ recovery facility to an oil production plant or a geological storage site.

3. The power generation system using low-grade coal according to claim 1, wherein:
the low-grade coal refining facility is provided near a coal mine from which the low-grade coal is produced.

4. The power generation system using low-grade coal according to claim 2, wherein:
the low-grade coal refining facility is provided near a coal mine from which the low-grade coal is produced.

5. The power generation system using low-grade coal according to claim 2, wherein:
the CO₂ transportation facility is a pipeline that connects the low-grade coal refining facility with the CO₂ recovery facility.

6. The power generation system using low-grade coal according to claim 3, wherein:
the CO₂ transportation facility is a pipeline that connects the low-grade coal refining facility with the CO₂ recovery facility.

7. The power generation system using low-grade coal according to claim 4, wherein:
the CO₂ transportation facility is a pipeline that connects the low-grade coal refining facility with the CO₂ recovery facility.
